(19) United States
(12) Patent Application Publication
(10) Pub. No.: US 2017/0004434 A1
(43) Pub. Date: Jan. 5, 2017

(54) Determining Individual Performance Dynamics Using Federated Interaction Graph Analytics

(71) Applicant: International Business Machines Corporation, Armonk, NY (US)

(72) Inventors: Kuntal Dey, West Bengal (IN); Amit Anil Nanavati, New Delhi (IN); Mangala Gowri Nanda, New Delhi (IN)

(21) Appl. No.: 14/755,709

(22) Filed: Jun. 30, 2015

(51) Int. Cl. G06Q 10/06; G06F 17/30

(52) U.S. Cl. CPC G06Q 10/06398; G06F 17/30477

(57) ABSTRACT

Methods, systems, and computer program products for determining performance dynamics are provided herein. A method includes generating a graph encompassing multiple dimensions representing types of interactions among multiple individuals within an organization, wherein each node of the graph corresponds to one of the multiple individuals, and each edge of the graph connects pairs of the nodes and corresponds to one of the dimensions; performing computations based on analysis of the graph to capture correlations of performance characteristics between the multiple individuals; calculating a performance rating of one of the multiple individuals based on (i) each correlation between the multiple individuals that include the given individual and (ii) a comparison of performance data of the given individual to performance data of each of the multiple individuals embodied in the correlations that include the given individual; and determining recommended work items for the given individual and/or the organization based on said calculating.

### FIELD

The present application generally relates to information technology, and, more particularly, to employee performance measurement techniques within an organization context.

### BACKGROUND

Analysis of career growth and career movement of employees within given organizations presents multiple challenges. Existing analysis approaches, for example, fail to encompass and integrate various aspects such as technical, social and organizational parameters pertaining to a given employee or individual.

### SUMMARY

In one aspect of the present invention, techniques for determining individual performance dynamics using federated interaction graph analytics are provided. An exemplary computer-implemented method can include steps of generating a graph encompassing multiple dimensions, each of said multiple dimensions representing one or more types of interactions among multiple individuals within an organization, wherein each of multiple nodes of the graph corresponds to a distinct one of the multiple individuals, and each of multiple edges of the graph connects one or more pairs of the multiple nodes and corresponds to one of the multiple dimensions, and wherein said generating is executed by a computing device in communication with an organization database, wherein the organization database comprises (i) organization interaction data for the multiple individuals and (ii) performance data for the multiple individuals, and wherein said generating the graph comprises deriving the organization interaction data from the organization database. Such a method also includes performing one or more computations based on analysis of the graph, wherein the one or more computations capture one or more correlations of one or more performance characteristics between the multiple individuals within the organization, wherein said performing is executed by the computing device in communication with the organization database. Additionally, such a method further includes calculating a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed by the computing device in communication with the organization database. Such a method also includes determining and outputting one or more recommended actionable work items for the given individual and/or the organization based on said calculating, wherein said determining and said outputting are executed by the computing device.

In another aspect of the invention, an exemplary computer-implemented method can include steps of generating a graph encompassing multiple dimensions, each of said multiple dimensions representing one or more types of interactions among multiple individuals within an organization, wherein each of multiple nodes of the graph corresponds to one of the multiple individuals, and each of multiple edges of the graph connects one or more pairs of the multiple nodes and corresponds to one of the multiple dimensions, and wherein said generating is executed by a computing device in communication with an organization database, wherein the organization database comprises (i) organization interaction data for the multiple individuals and (ii) performance data for the multiple individuals, and wherein said generating the graph comprises deriving the organization interaction data from the organization database. Such a method additionally includes performing one or more computations based on analysis of the graph, wherein the one or more computations capture one or more correlations across multiple performance characteristics between the multiple individuals within the organization, wherein said performing is executed by the computing device in communication with the organization database. Also, such a method includes calculating a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed by the computing device in communication with the organization database. Such a method further includes determining one or more recommended actionable work items for the given individual and/or the organization based on (i) said performance rating and (ii) and one or more organization objectives, wherein said determining and said outputting are executed by the computing device. Also, such a method includes generating a performance report for the organization based on (i) said graph, (ii) said one or more computations, and (iii) said one or more recommended actionable work items for the given individual and/or the organization.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an example embodiment of the invention;

FIG. 2 is a flow diagram illustrating techniques according to an embodiment of the invention; and

FIG. 3 is a system diagram of an exemplary computer system on which at least one embodiment of the invention can be implemented.

### DETAILED DESCRIPTION

As described herein, an aspect of the present invention includes techniques for determining individual performance dynamics using federated interaction graph analytics. At least one embodiment of the invention includes creating a federated interaction graph across multiple dimensions by computing matrices and capturing the correlation of a given graph, wherein the multiple dimensions can include a social dimension (for example, an email network, an instant messenger network, a social discussion forum and/or a social friendship platform), a technical dimension (for example, projects, research papers and patents) and an organizational dimension (for example, organizational reporting).

By way merely of example and illustration, consider the following setting. An organization has the following activities defined over its employees that result in inter-employee interaction and that can be used for the construction of dimension graphs: an email network, an instant messenger network, a social discussion forum, a social friendship platform, an organizational reporting chain of a maximum of three levels, projects, research papers, patents, etc. Further, the employees of the organization are rated, wherein the ratings correspond to employee performance. In this example setting, there are three ratings: a rating of 1 for employees having shown excellent performance within the organization, a rating of 2 for employees having shown average performance within the organization, and a rating of 2+ for employees having shown above average performance within the organization. Additionally, the organization has three dimension types available for categorizing dimensions: technical, organizational, and social.

In such an example setting, at least one embodiment of the invention can include constructing dimension graphs. As noted, in this setting, dimension graphs can be constructed from an email network (wherein an edge is between “to” and “from” nodes of emails), an instant messenger network (wherein “chatting parties” serve as edges), a social discussion forum (wherein an edge is between each pair of contributors), a social friendship forum (wherein an edge is between each pair forming a friendship), an organizational reporting chain of a maximum of three levels (wherein an edge is between each level, and each upper level directly or transitively connected to this level, ignoring edges at the same level or downward edges), projects (wherein an edge is between each pair of co-workers in a given project), research papers (wherein an edge is between each pair of co-authors in a given research paper), and patents (wherein an edge is between each pair of co-inventors in a given patent). Using dimension graphs and given dimension types available for categorization, the following categorization output can be obtained: technical (projects, research papers, and patents), organizational (organizational reporting), and social (email network, instant messenger network, social discussion forum, and social friendship platform).

Additionally, such an example embodiment can also include creating three matrices using the dimensions and dimension type graphs. By way of example, absolute rating matrices can be computed first, followed by the computation of difference rating matrices. Finally, the example embodiment of the invention can include computing an affinity ratio matrix for the entire given (dimension or dimension type) graph. In such an example embodiment, the matrices can be created with dimension types that include technical, organizational and social. Also, an affinity ratio matrix can be computed, as noted, for each sub-organization, across three different dimension types, and across all of the ratings with respect to a rating of one.

As detailed herein, at least one embodiment of the invention includes correlating data (such as federated graphs), wherein inferences can be made by a correlator component, from one or more observed tables. By way of example, consider a context wherein one-rated employees do not mix well with other one-rated employees in any of technical, organizational or social aspects, across sub-organizations. Also, one-rated employees may tend to perform well while technically collaborating with employees with a two-plus rating, and one-rated employees may also tend to mix well with employees with a two-plus rating in an example organization. Additionally, one-rated and two-rated employees tend to socialize infrequently with each other. Further, in many instances, one-rated employees tend to collaborate more with other one-rated employees, as compared to two-rated employees.

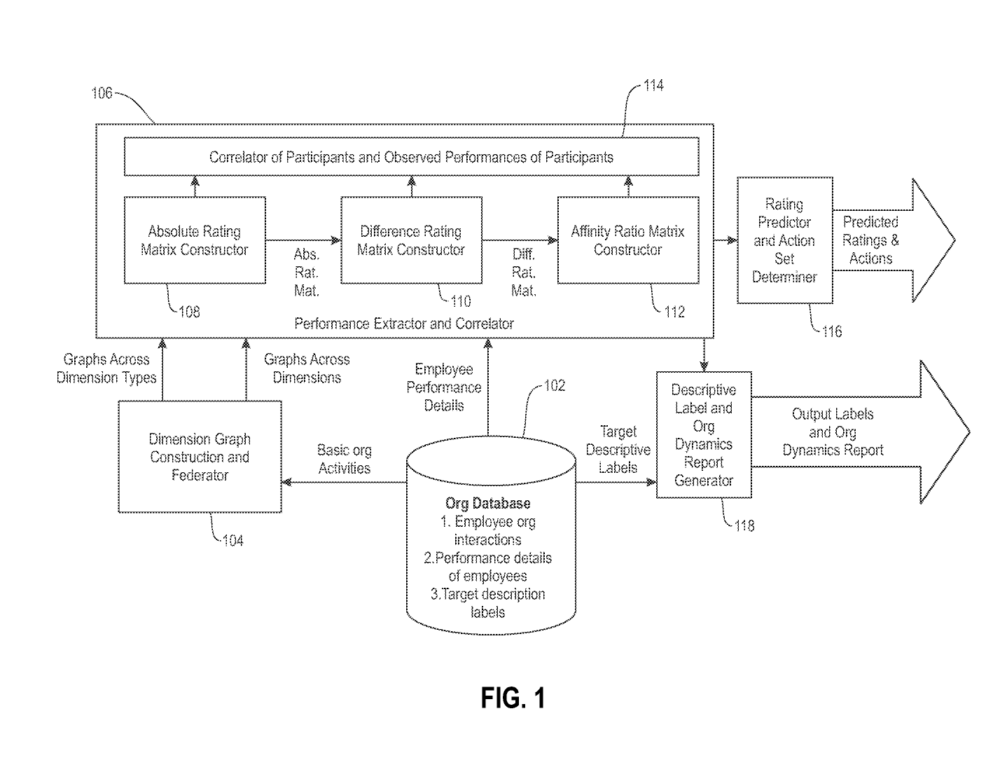

One or more embodiments of the invention also include labeling and reporting. In a labeling and report generation phase, each correlated federated graph is labeled from descriptive labels available in an existing set of labels. The existing set of labels is to be given as input, for example, from a database (such as database 102 depicted in FIG. 1). By way of example, there can be multiple labels in the set indicating a rating (such as 1, 2+, 2, etc.), a front or dimension (technical, social, organizational, etc.), a sub-organization and/or division (research, finance, sales, marketing etc.), and/or a status that is found in the target sub-organization (negative, positive, or neutral).

Additionally, using a template description available with the labels, an automated report can be generated. For example, one-rated employees from a first organization (org 1), in a given example embodiment of the invention, can bear the following label, among others: <mix: negative, rating: 1, front: technical, sub-organization: org1>. Correspondingly, a report will include the following sentence (using the template), among others: “Does not tend to mix well with other one-rated employees, in the technical front, with other employees in sub-organization org 1.”

As detailed herein, at least one embodiment of the invention additionally includes a social network analysis. By way of example, consider the following observations in connection with an example embodiment of the invention:
(Type Technical, Rating 1): In both of two example organizational divisions, the technical collaboration is maximal from superstars to stars. In the given example, superstars are the most highly-rated employees (that is, employees with rating of 1), and stars are employees that are rated just below the superstars but higher than average (that is, those having a rating of 2+), assuming that the average performance employees have a rating of 2.

(Type Technical, Rating 2+): In a given first division, stars collaborate frequently (an affinity ratio of approximately 1.5) with superstars. A given second division shows no such trend; and
(Type Technical, Rating High).

Additionally, in the given example, in the given first division, achievers collaborate significantly (greater than an affinity ratio of 1.5) with other achievers (for example, a combination of rating 1 and rating 2+ employees). In the given second division, the trend is slightly above average (an affinity ratio of 1.13).

Also, consider the following additional observations in connection with an example embodiment of the invention:
(Type Organizational, Rating 2+): In the given first division, the stars are organizationally (T2; that is, the organizational graph) and significantly (a ratio of greater than two) close to superstars and also frequently (an affinity ratio of greater than 1.5) close to themselves. This implies that the given first division comprises organizations that are successful and possibly other organizations that are not. This trend is absent in the given second division.
(Type Organizational, Rating High): In the given first division, success comes significantly (an affinity ratio of greater than three) at an organizational level (second level management—T2). In the given second division, the same trend exists but not as prominently.

Additionally, consider the following additional observation in connection with an example embodiment of the invention:
(Type Social, Rating 2): Two-rated employees show no significant social preferences in the given second division. In the given first division, two-rated employees form strong (an affinity ratio of approximately three) (outgoing) social connections with stars (that is, employees having a rating of 2+).

At least one embodiment of the invention includes implementing quantification matrices. By way of example, for each federated graph obtained, at least one embodiment of the invention includes implementing multiple quantification matrices to capture the correlation of the graph with performance characteristics observed among the participants of the graph. Additionally, one or more embodiments of the invention include utilizing such matrices to qualify the overall nature of performance dynamics of the employees of a given organization and assigning descriptive labels to each elicited qualitative behavior to generate organizational performance causality and characteristic reports, including comparisons across sub-organizations within the organization.

Accordingly, as detailed herein, at least one embodiment of the invention includes identifying a set of dimension graphs, categorizing the dimension graphs into different given dimension types (for example, social, technical, and/or organizational), computing various matrices based on the dimension graphs, predicting and/or generating ratings of individuals and/or organizations, and designing an action plan for target individuals and/or organizations.

Such an embodiment includes defining dimensions and dimension types, given a set of distinct elementary organizational interactions in which all of the dimension graphs in the set have the same set of nodes (also referred to herein as vertices) representing employees of the organization. However, each distinct dimension graph has a different type of edge set, wherein each edge set captures a distinct causality of edge formation including, but not limited to, technical, organizational, social, personal and external causalities. At least one embodiment of the invention also includes categorizing the edge set causalities into different given dimensions and the dimensions formed thereby into different given dimension types. As noted herein, any of a dimension graph, a dimension type graph and any combination thereof is referred to herein as a “federated graph.”

Additionally, at least one embodiment of the invention includes defining required matrices, given a set of elementary organizational interaction graphs of employees, wherein each graph represents a dimension, a dimension type, or a complete federation of all of the elementary organizational interaction graphs. Such matrices can include a set of number-prefixed, number-suffixed or distinct numerical ratings (categorical ratings), in which the notions associated with the consecutive ratings vary monotonically with respect to actual employee performance within the organization.

For each graph, an example embodiment of the invention can include, as noted herein, defining three matrices that include an absolute rating matrix, a difference rating matrix, and an affinity ratio matrix. An absolute rating matrix captures the absolute fraction of connections of a certain rating for a given rating and a given graph. Defining an absolute rating matrix includes examining the nodes (representing people) and the ratings of the nodes (people) connected thereto. For example, assume that person A is connected to five people that have a rating of one, seven people that have a rating two-plus, and nine people that have a rating of two in a certain type of federated dimension graph. Accordingly, the goodness score for a “one” connection=5/(5+7+9)=5/21, the goodness score for a “two-plus” connection=7/21, and so on.

Defining a difference rating matrix includes, for each node (also referred to herein as a vertex) in each graph type and for each rating, computing the difference of the actual proportion of connections with a given rating with the expected (average) connection for each kind of rating. An absolute rating matrix is used as input to this computation. To continue with the above example, the actual connection of person A with people that have a rating of one will have a proportion of 5/(5+7)=5/12. To determine the expected number of connections, at least one embodiment of the invention includes computing the ratio of total number of one-rated people in the organization and the total number of people in the organization. For example, if person A's organization, which employs a total of 100 people, includes 30 people with a rating of one, then the expected (random) connection proportion of a random person (say, A) in the organization to another person in the same organization with rating of one is 30/100. Accordingly, the difference rating matrix element at the cell (A, 1) will have the value (5/12−30/100)=0.1167.

One or more embodiments of the invention can include similarly constructing other rating cells for the connections of A, namely for ratings of two-plus and two. Additionally, such an embodiment can further include repeating this process along the matrix to complete construction of the difference rating matrix.

Also, at least one embodiment of the invention can include creating a refined scheme for predicting the expectations of ratings of any given individual from any given federated dimension, given connections to other individuals within the same federated dimension (found from a corresponding dimension graph). Such an embodiment can further include recommending actionable work items based upon the outcome of the prediction process and one or more organizational and/or business objectives.

Defining an affinity ratio matrix includes, for each graph type and each given rating, carrying out a computation process across the graph type and across the ratings. An affinity ratio matrix captures a sense of assortativity in the overall (global) graph, and a difference rating matrix is used as input to the computation. For each given rating in a given graph type, at least one embodiment of the invention includes determining the number of people of the given rating having a positive element (P) in the difference rating matrix, as well as determining the number of people having a negative element (N) in the difference rating matrix. Accordingly, at least one embodiment of the invention includes computing a P/N ratio for each rating to construct the affinity ratio matrix.

In one or more embodiments of the invention, an affinity ratio is cumulative over an entire graph type, wherein the affinity ratio can range from zero to one, with a value of one indicating a strong overall collaboration.

FIG. 1 is a diagram illustrating system architecture, according to an embodiment of the invention. By way of illustration, FIG. 1 depicts an organizational database 102, a dimension graph constructor and federator component 104, a performance extractor and correlator component 106, a descriptive label and organization dynamics report generator component 118, and a rating predictor and action set determiner component 116.

The organizational database 102 stores information such as, for example, employee interaction data, performance details of one or more employees (within the organization), and target descriptive labels. The organizational database 102 provides input (such as, for example, information pertaining to basic organizational activities) to the dimension graph constructor and federator component 104, and also provides input (such as, for example, employee performance details) to the performance extractor and correlator component 106. Further, the organizational database 102 additionally provides input (such as, for example, target descriptive labels) to the descriptive label and organization dynamics report generator component 118.

The dimension graph constructor and federator component 104 generates one or more graphs across multiple dimensions as well as one or more graphs across multiple dimension types, and provides the same to the performance extractor and correlator component 106. The performance extractor and correlator component 106, as depicted in FIG. 1, includes an absolute rating matrix constructor component 108, a difference rating matrix constructor component 110, an affinity ratio matrix constructor component 112, and a correlator component 114 for participants and observed performances of participants. The absolute rating matrix constructor component 108 generates and provides an absolute rating matrix to the difference rating matrix constructor component 110 as well as the correlator component 114. The difference rating matrix constructor component 110 generates and provides a difference ratio matrix to the affinity ratio matrix constructor component 112 as well as the correlator component 114. Additionally, the affinity ratio matrix constructor component 112 generates and provides an affinity ratio matrix to the correlator component 114.

As detailed herein, component 108 determines the absolute rating matrix by examining the actual fraction of employees of a given rating to which a given employee is connected. Component 110 determines the difference rating matrix of an employee by computing the difference of the actual fraction of employees of a given rating to which an employee is connected and the probabilistic (expected) number of employees of that rating to which s/he ought to be connected (if connections were made at random). Component 112 determines the affinity ratio matrix by aggregating the number of cases in which the outcome of component 110 is positive (>0) and the number of cases in which the outcome of component 110 is negative (<0), and by taking a ratio of the two. Component 114 correlates the behavior from all employees under consideration and aggregates the values determined by components 108, 110 and 112 to form a collective statistic of the observed behavior in the sub-organization(s) and the employees within the sub-organization(s). Component 114 also correlates the employee-level behavior and organization-level behavior at a per-employee (and per-org) level.

Ultimately, the performance extractor and correlator component 106 provides input to the rating predictor and action set determiner component 116, and also provides input to the descriptive label and organization dynamics report generator 118. Specifically, the outputs of components 108, 110, 112 and 114 are provided as input to component 116, and the outputs of components 108, 110, 112 and 114, as well as the target label present in component 102, are provided as input to component 118. Further, the rating predictor and action set determiner component 116 outputs predicted ratings and actions, while the descriptive label and organization dynamics report generator 118 outputs labels and an organization dynamics report to a user (for example, a client (organization)).

As detailed herein, one or more embodiments of the invention includes creating and federating multiple dimension graphs (constructed from a combination of one or more elementary employee interaction data sets) within any given dimension type, as well as multiple graphs across different dimension types in the context of measuring the organizational performance dynamics of employees. At least one embodiment of the invention includes implementing and/or incorporating a classification of networks into multiple dimension types, such as, for example, social, technical and organizational. Such a classification can facilitate in providing insights in terms of which network to affect (change) to influence the individual and/or the organization.

Also, as described herein, one or more embodiments of the invention include computing quantification matrices, such as a difference rating matrix, an affinity ratio matrix and an absolute rating matrix, to capture the correlation of a given graph with performance characteristics observed among the participants of the graph. Such an embodiment can also include, as noted herein, predicting the rating of an individual based on the ratings of his or her network neighbors across multiple dimension graphs. Such a rating can subsequently be utilized to compare how relatively predictive dimension graphs are, so as to plan and/or determine actions for performance improvement of individuals and/or organizations.

For each federated graph obtained, one or more embodiments of the invention include capturing the correlation of a given graph between participants of the graph as well as the performance characteristics observed among the participants of the graph, using multiple quantification matrices. Such an embodiment can additionally include qualifying the overall nature of performance dynamics of the organization employees, and assigning descriptive labels to each qualitative behavior from a given set of descriptive labels. At least one embodiment of the invention can further include, in an employee organization performance dynamics measurement context, categorizing edge set causalities into different dimensions, and also categorizing the dimensions into different given dimension types. Such categorization techniques facilitate the generation of organizational performance causality and characteristic reports, including comparisons across sub-organizations within the organization.

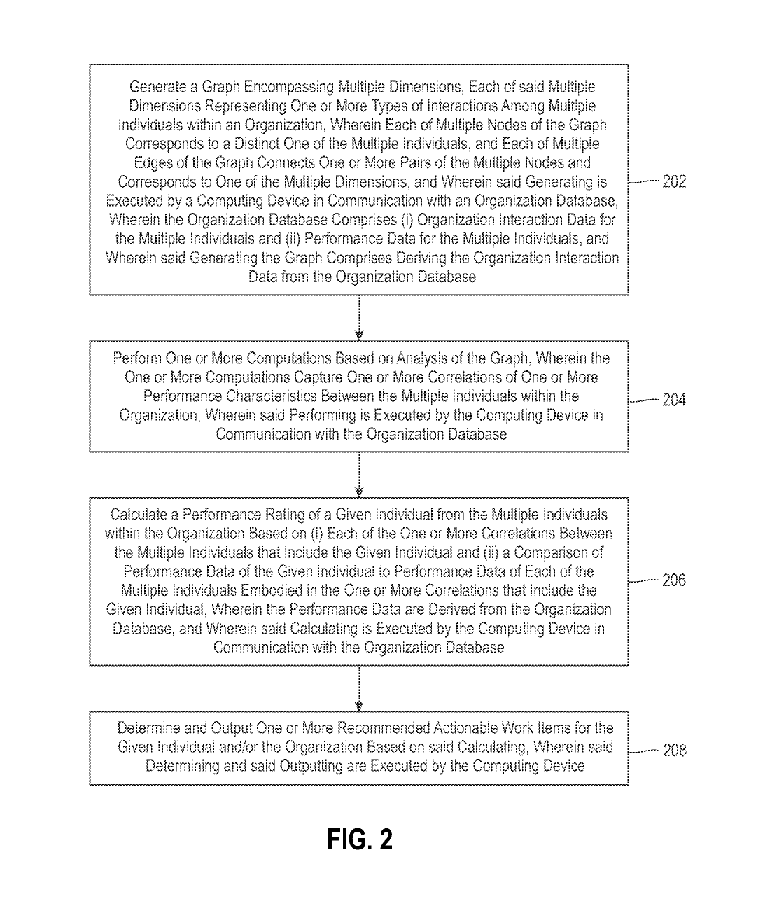

FIG. 2 is a flow diagram illustrating techniques according to an embodiment of the present invention. Step 202 includes generating a graph encompassing multiple dimensions, each of said multiple dimensions representing one or more types of interactions among multiple individuals within an organization, wherein each of multiple nodes of the graph corresponds to a distinct one of the multiple individuals, and each of multiple edges of the graph connects one or more pairs of the multiple nodes and corresponds to one of the multiple dimensions, and wherein said generating is executed by a computing device in communication with an organization database, wherein the organization database comprises (i) organization interaction data for the multiple individuals and (ii) performance data for the multiple individuals, and wherein said generating the graph comprises deriving the organization interaction data from the organization database.

As detailed herein, the multiple dimensions can include (i) a social dimension, (ii) a technical dimension and (iii) an organizational dimension. The social dimension captures interactions among the multiple individuals within the organization within the context of an email network, an instant messenger network, a social discussion forum and/or a social networking platform. Also, the technical dimension captures interactions among the multiple individuals within the organization within the context of one or more projects, one or more research papers and/or one or more patent applications. Additionally, the organizational dimension captures interactions among the multiple individuals within the organization within the context of organizational reporting.

Step 204 includes performing one or more computations based on analysis of the graph, wherein the one or more computations capture one or more correlations of one or more performance characteristics between the multiple individuals within the organization, wherein said performing is executed by the computing device in communication with the organization database.

The one or more computations can include one or more quantification matrices. The one or more quantification matrices can include an absolute rating matrix, wherein the absolute rating matrix captures an absolute fraction of connections of a given performance rating for the given performance rating and the graph. Also, the one or more quantification matrices can include a difference rating matrix, wherein the difference rating matrix captures a difference of an actual proportion of connections with a given performance rating with an expected connection for each of multiple performance ratings. Further, the one or more quantification matrices can include an affinity ratio matrix, wherein the affinity ratio matrix captures assortativity in the graph by computing a ratio of (i) a count of a population wherein the difference rating matrix has a positive value to (ii) a count of the population wherein the difference rating matrix has a negative value.

Step 206 includes calculating a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed by the computing device in communication with the organization database.

Step 208 includes determining and outputting one or more recommended actionable work items for the given individual and/or the organization based on said calculating, wherein said determining and said outputting are executed by the computing device.

The techniques depicted in FIG. 2 can also include assigning a descriptive label associated with each of multiple qualitative performance characteristics to each of the multiple individuals within the organization.

Also, an additional aspect of the invention includes techniques that include generating a graph encompassing multiple dimensions, each of said multiple dimensions representing one or more types of interactions among multiple individuals within an organization, wherein each of multiple nodes of the graph corresponds to one of the multiple individuals, and each of multiple edges of the graph connects one or more pairs of the multiple nodes and corresponds to one of the multiple dimensions, and wherein said generating is executed by a computing device in communication with an organization database, wherein the organization database comprises (i) organization interaction data for the multiple individuals and (ii) performance data for the multiple individuals, and wherein said generating the graph comprises deriving the organization interaction data from the organization database. Such techniques additionally include performing one or more computations based on analysis of the graph, wherein the one or more computations capture one or more correlations across multiple performance characteristics between the multiple individuals within the organization, wherein said performing is executed by the computing device in communication with the organization database. Also, such techniques include calculating a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed by the computing device in communication with the organization database. Such techniques further include determining one or more recommended actionable work items for the given individual and/or the organization based on (i) said performance rating and (ii) and one or more organization objectives, wherein said determining and said outputting are executed by the computing device. Also, such techniques include generating a performance report for the organization based on (i) said graph, (ii) said one or more computations, and (iii) said one or more recommended actionable work items for the given individual and/or the organization.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

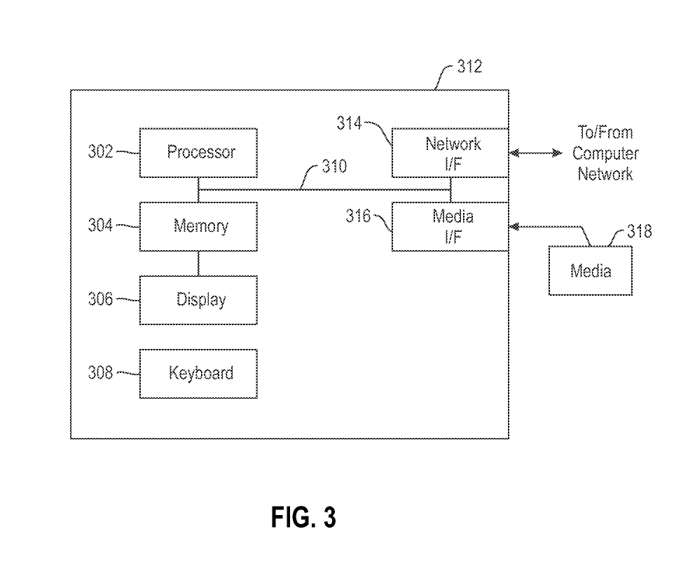

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, computing matrices and capturing the correlation of a given graph thereto to measure performance of an individual using dimensions including social, technical and organizational.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating a graph encompassing multiple dimensions, each of said multiple dimensions representing one or more types of interactions among multiple individuals within an organization, wherein each of multiple nodes of the graph corresponds to a distinct one of the multiple individuals, and each of multiple edges of the graph connects one or more pairs of the multiple nodes and corresponds to one of the multiple dimensions, and wherein said generating is executed by a computing device in communication with an organization database, wherein the organization database comprises (i) organization interaction data for the multiple individuals and (ii) performance data for the multiple individuals, and wherein said generating the graph comprises deriving the organization interaction data from the organization database;
performing one or more computations based on analysis of the graph, wherein the one or more computations capture one or more correlations of one or more performance characteristics between the multiple individuals within the organization, wherein said performing is executed by the computing device in communication with the organization database;
calculating a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed by the computing device in communication with the organization database; and
determining and outputting one or more recommended actionable work items for the given individual and/or the organization based on said calculating, wherein said determining and said outputting are executed by the computing device.

2. The method of claim 1, wherein the multiple dimensions comprise (i) a social dimension, (ii) a technical dimension and (iii) an organizational dimension.

3. The method of claim 2, wherein the social dimension captures interactions among the multiple individuals within the organization within the context of an email network, an instant messenger network, a social discussion forum and/or a social networking platform.

4. The method of claim 2, wherein the technical dimension captures interactions among the multiple individuals within the organization within the context of one or more projects, one or more research papers and/or one or more patent applications.

5. The method of claim 2, wherein the organizational dimension captures interactions among the multiple individuals within the organization within the context of organizational reporting.

6. The method of claim 1, wherein the one or more computations comprise one or more quantification matrices.

7. The method of claim 6, wherein the one or more quantification matrices comprises an absolute rating matrix, wherein the absolute rating matrix captures an absolute fraction of connections of a given performance rating for the given performance rating and the graph.

8. The method of claim 6, wherein the one or more quantification matrices comprises a difference rating matrix, wherein the difference rating matrix captures a difference of an actual proportion of connections with a given performance rating with an expected connection for each of multiple performance ratings.

9. The method of claim 8, wherein the one or more quantification matrices comprises an affinity ratio matrix, wherein the affinity ratio matrix captures assortativity in the graph by computing a ratio of (i) a count of a population wherein the difference rating matrix has a positive value to (ii) a count of the population wherein the difference rating matrix has a negative value.

10. The method of claim 1, comprising:
assigning a descriptive label associated with each of multiple qualitative performance characteristics to each of the multiple individuals within the organization.

11. A computer program product, the computer program product comprising a computer readable storage medium having program instructions embodied therewith, the program instructions executable by a computing device to cause the computing device to:
generate a graph encompassing multiple dimensions, each of said multiple dimensions representing one or more types of interactions among multiple individuals within an organization, wherein each of multiple nodes of the graph corresponds to a distinct one of the multiple individuals, and each of multiple edges of the graph connects one or more pairs of the multiple nodes and corresponds to one of the multiple dimensions, and wherein said generating is executed by a computing device in communication with an organization database, wherein the organization database comprises (i) organization interaction data for the multiple individuals and (ii) performance data for the multiple individuals, and wherein said generating the graph comprises deriving the organization interaction data from the organization database;
perform one or more computations based on analysis of the graph, wherein the one or more computations capture one or more correlations of one or more performance characteristics between the multiple individuals within the organization, wherein said performing is executed by the computing device in communication with the organization database;
calculate a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed by the computing device in communication with the organization database; and
determine and output one or more recommended actionable work items for the given individual and/or the organization based on said calculating, wherein said determining and said outputting are executed by the computing device.

12. The computer program product of claim 11, wherein the multiple dimensions comprise (i) a social dimension, (ii) a technical dimension and (iii) an organizational dimension.

13. The computer program product of claim 12, wherein the social dimension captures interactions among the multiple individuals within the organization within the context of an email network, an instant messenger network, a social discussion forum and/or a social networking platform.

14. The computer program product of claim 12, wherein the technical dimension captures interactions among the multiple individuals within the organization within the context of one or more projects, one or more research papers and/or one or more patent applications.

15. The computer program product of claim 12, wherein the organizational dimension captures interactions among the multiple individuals within the organization within the context of organizational reporting.

16. The computer program product of claim 11, wherein the one or more computations comprise one or more quantification matrices.

17. The computer program product of claim 11, wherein the program instructions executable by the computing device further cause the computing device to:
assign a descriptive label associated with each of multiple qualitative performance characteristics to each of the multiple individuals within the organization.

18. A system comprising:
a memory; and
at least one processor coupled to the memory and configured for:
generating a graph encompassing multiple dimensions, each of said multiple dimensions representing one or more types of interactions among multiple individuals within an organization, wherein each of multiple nodes of the graph corresponds to a distinct one of the multiple individuals, and each of multiple edges of the graph connects one or more pairs of the multiple nodes and corresponds to one of the multiple dimensions, and wherein said generating is executed in communication with an organization database, wherein the organization database comprises (i) organization interaction data for the multiple individuals and (ii) performance data for the multiple individuals, and wherein said generating the graph comprises deriving the organization interaction data from the organization database;
performing one or more computations based on analysis of the graph, wherein the one or more computations capture one or more correlations of one or more performance characteristics between the multiple individuals within the organization, wherein said performing is executed in communication with the organization database;
calculating a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed in communication with the organization database; and
determining and outputting one or more recommended actionable work items for the given individual and/or the organization based on said calculating.

19. A method, comprising:
generating a graph encompassing multiple dimensions, each of said multiple dimensions representing one or more types of interactions among multiple individuals within an organization, wherein each of multiple nodes of the graph corresponds to one of the multiple individuals, and each of multiple edges of the graph connects one or more pairs of the multiple nodes and corresponds to one of the multiple dimensions, and wherein said generating is executed by a computing device in communication with an organization database, wherein the organization database comprises (i) organization interaction data for the multiple individuals and (ii) performance data for the multiple individuals, and wherein said generating the graph comprises deriving the organization interaction data from the organization database;
performing one or more computations based on analysis of the graph, wherein the one or more computations capture one or more correlations across multiple performance characteristics between the multiple individuals within the organization, wherein said performing is executed by the computing device in communication with the organization database;
calculating a performance rating of a given individual from the multiple individuals within the organization based on (i) each of the one or more correlations between the multiple individuals that include the given individual and (ii) a comparison of performance data of the given individual to performance data of each of the multiple individuals embodied in the one or more correlations that include the given individual, wherein the performance data are derived from the organization database, and wherein said calculating is executed by the computing device in communication with the organization database;
determining one or more recommended actionable work items for the given individual and/or the organization based on (i) said performance rating and (ii) and one or more organization objectives, wherein said determining and said outputting are executed by the computing device; and
generating a performance report for the organization based on (i) said graph, (ii) said one or more computations, and (iii) said one or more recommended actionable work items for the given individual and/or the organization.

20. The method of claim 19, wherein the multiple dimensions comprise (i) a social dimension, (ii) a technical dimension and (iii) an organizational dimension.
